(19) United States
(12) Patent Application Publication
(10) Pub. No.: US 2025/0207979 A1
(43) Pub. Date: Jun. 26, 2025

(54) BARBECUE TEMPERATURE PROBE

(71) Applicant: SHENZHEN QIANFENYI INTELLIGENT TECHNOLOGY CO., LTD, Shenzhen (CN)

(72) Inventors: Yanxin HUANG, Shenzhen (CN); Duhao QING, Shenzhen (CN); Ziyu ZHAN, Shenzhen (CN)

(73) Assignee: SHENZHEN QIANFENYI INTELLIGENT TECHNOLOGY CO., LTD, Shenzhen (CN)

(21) Appl. No.: 18/924,178

(22) Filed: Oct. 23, 2024

Related U.S. Application Data
(63) Continuation of application No. PCT/CN2024/115171, filed on Aug. 28, 2024.

(30) Foreign Application Priority Data
Dec. 20, 2023 (CN) 202323495258.7
Dec. 28, 2023 (CN) 202323630100.6
Feb. 19, 2024 (CN) 202410182663.3
Feb. 19, 2024 (CN) 202420301420.2
May 20, 2024 (CN) 202421129014.9
Jul. 1, 2024 (CN) 202410869209.5
Jul. 1, 2024 (CN) 202410869214.6

(51) Int. Cl. G01K 1/024; G01K 7/02; G01K 11/12

(52) U.S. Cl. CPC G01K 1/024; G01K 7/02; G01K 11/12; G01K 2215/00

(57) ABSTRACT

A barbecue temperature probe includes a measuring portion, a holding portion and a temperature sensing portion. The measuring portion includes a needle body and a temperature sensor, and the temperature sensor is fixedly installed in the needle body and configured to convert a temperature signal of the needle body to an electrical signal; the holding portion is fixedly connected to one end of the measuring portion; and the temperature sensing portion is provided on an outer surface of the measuring portion and an outer surface of the holding portion, and the temperature sensing portion is configured to sense a temperature of an outer surface of the barbecue temperature probe and change morphological characteristics with a temperature change.

### CROSS-REFERENCE TO RELATED APPLICATIONS

The present application is a continuation application of International Application No. PCT/CN2024/115171, filed on Aug. 28, 2024, which claims priority to Chinese Patent Application No. 202421129014.9, filed on May 20, 2024, Chinese Patent Application No. 202323630100.6, filed on Dec. 28, 2023, Chinese Patent Application No. 202323495258.7, filed on Dec. 20, 2023, Chinese Patent Application No. 202420301420.2, filed on Feb. 19, 2024, Chinese Patent Application No. 202410869214.6, filed on Jul. 1, 2024, Chinese Patent Application No. 202410869209.5, filed on Jul. 1, 2024, and Chinese Patent Application No. 202410182663.3, filed on Feb. 19, 2024. The disclosures of the above-mentioned applications are incorporated herein by reference in their entireties.

### TECHNICAL FIELD

The present application relates to the technical field of temperature monitoring, and in particular to a barbecue temperature probe.

### BACKGROUND

The barbecue temperature probe is a device that can be used to measure the internal temperature of food and has been widely used in people's daily lives. The probe can help chefs accurately grasp the degree of food cooking during the cooking process, ensure the taste and safety of the food, improve the quality and efficiency of cooking in both home kitchens and commercial kitchens, and help people make safe and delicious food.

Among the barbecue temperature probe currently available on the market, there is a technology that involves inserting the probe into the food and puts it into a high-temperature environment with the food to continuously monitor the degree of food cooking. The method is generally to insert a stainless steel probe into the food, such as various fresh meats, and to put the food with the probe inserted into a cooking appliance such as an electric barbecue grill, a smoker, an oven, a grill, a frying pan, etc., and to determine the degree of food cooking through temperature until the cooking is finished. However, there is a problem in the use of this barbecue temperature probe, that is, whether during cooking or at the end of cooking, without the help of an external device, the user cannot estimate the temperature of the outer surface of the probe. If the user touches the probe when the outer surface of the probe is still at a high temperature, it may cause burns. The barbecue temperature probe lacks guidance about the temperature of its own outer surface.

### SUMMARY

The main purpose of the present application is to provide a barbecue temperature probe, which is intended to remind and guide users of the temperature on the outer surface of the barbecue temperature probe.

To achieve the above purpose, the present application provides a barbecue temperature probe, including a measuring portion, a holding portion and a temperature sensing portion.

The measuring portion includes a needle body and a temperature sensor, the temperature sensor is fixedly installed in the needle body and configured to convert a temperature signal of the needle body to an electrical signal; the holding portion is fixedly connected to one end of the measuring portion; and the temperature sensing portion is provided on an outer surface of the measuring portion and an outer surface of the holding portion, the temperature sensing portion is configured to sense a temperature of an outer surface of the barbecue temperature probe and change morphological characteristics with a temperature change.

In an embodiment, the needle body includes: a middle tube, and a tip end and a connecting end provided at both ends of the middle tube; and a diameter of the tip end is configured to gradually decrease from the middle tube towards a direction away from the connecting end, and the connecting end is fixedly connected to the holding portion.

In an embodiment, the barbecue temperature probe further includes a conductive member provided at one end of the holding portion close to the needle body, the temperature sensor is electrically connected to the conductive member, so that the conductive member is configured as a charging electrode.

In an embodiment, the holding portion includes a hollow cylinder and an end cover, the end cover is provided at an opening of one end of the hollow cylinder, and one end of the hollow cylinder away from the end cover is sleeved on an outside of the connecting end.

In an embodiment, a peripheral wall of the connecting end is provided with a plurality of annular grooves, and a sealing member is provided in the annular groove and configured to seal and connect an inner circumferential wall of the hollow cylinder with the peripheral wall of the connecting end.

In an embodiment, the end cover includes a top plate and a connecting column extending from the top plate towards one side of the top plate, a peripheral wall of the connecting column is provided with a clamping groove, the connecting column is inserted into the hollow cylinder, and the clamping groove is configured to clamp with an inner sidewall of the hollow cylinder.

In an embodiment, the temperature sensing portion is provided at a middle part of an outer wall of the hollow cylinder where is touched by user's fingers.

In an embodiment, the barbecue temperature probe further includes a radio frequency antenna electrically connected to the temperature sensor, a thread portion is provided on the end cover, and the radio frequency antenna includes a spiral portion threadedly connected to the thread portion of the end cover.

In an embodiment, the hollow cylinder is provided with an accommodating chamber, a first opening and a second opening are provided at two ends of the accommodating chamber, the connecting end is sealingly connected to the first opening, and the end cover is sealingly connected to the second opening; and the second opening is provided with a waterproof structure.

In an embodiment, the waterproof structure includes a reverse interlock protruding from an inner wall of the accommodating chamber, a gap is formed between the reverse interlock and the inner wall of the accommodating chamber, and the end cover is inserted into the gap.

In an embodiment, the reverse interlock is provided at one end of the accommodating chamber close to the second opening, and an outer diameter of the reverse interlock is configured to gradually increase from the second opening towards the accommodating chamber.

In an embodiment, the barbecue temperature probe further includes a metal sealing member sleeved on a periphery of the connecting end, and the metal sealing member is configured to be deformed under an action of an external force, so that a diameter of the metal sealing member is adjustable; and the metal sealing member is in an interference fit with the inner wall of the accommodating chamber to sealingly connect the connecting portion to the body.

In an embodiment, the metal sealing member is in a non-closed ring shape with an opening; and the metal sealing member is made of copper.

In an embodiment, an outer diameter of the metal sealing member is configured to gradually decrease from one end close to the first opening towards an inside of the accommodating chamber, the metal sealing member includes a sealing body and a convex rib provided on an outer periphery of the sealing body, and the convex rib is in an interference fit with the inner wall of the accommodating chamber; and a plurality of convex ribs are provided at intervals along an axial direction of the metal sealing member, and a groove for filling colloid is formed between any two adjacent convex ribs.

In an embodiment, the needle body is provided with a safety line for marking a depth of the needle body inserted into food; and the temperature sensing portion is provided on one side of the needle body close to the holding portion and outside the safety line.

In an embodiment, the temperature sensing portion is coated with a thermochromic coating configured to change color with the temperature change.

In an embodiment, the barbecue temperature probe further includes a control module and a battery module for power supply, the control module is electrically connected to the temperature sensor, and the battery module is electrically connected to the control module and the temperature sensor.

In an embodiment, the barbecue temperature probe further includes a temperature-sensing member and a spiral antenna, the temperature-sensing member is provided in the needle body and along an extending direction of the needle body, and the spiral antenna is provided in the needle body; the spiral antenna includes an antenna body provided along the extending direction of the needle body, and a spiral structure provided in a middle section of the antenna body; and the spiral structure is provided around a periphery of the temperature-sensing member.

In an embodiment, a plurality of the spiral structures are coaxially provided at intervals along the extending direction of the needle body, and the spiral structure includes at least one spiral section provided along the extending direction of the needle body.

In an embodiment, the barbecue temperature probe further includes a circuit board provided in the shell, the spiral antenna further includes a first connecting portion provided at one end of the antenna body, and the first connecting portion is connected to the circuit board.

Beneficial effects that can be achieved by the present application are as follows.

In the present application, the external temperature is sensed through the temperature sensor in the measuring portion of the barbecue temperature probe to indicate the temperature of the stuff under test, the food probe is inserted into the stuff under test through the holding portion, and a temperature sensing portion is provided on the measuring portion and/or the holding portion. The temperature sensing portion can change its own state with the change of the temperature of the outer surface of the measuring portion and the holding portion, and indicate the temperature of the outer surface of the measuring portion and the holding portion at this time through the change of the state of the temperature sensing portion. The barbecue temperature probe in the present application senses the temperature of the outer surface of the barbecue temperature probe by setting the temperature sensing portion and changes its own morphological characteristics with the temperature, so that the user can intuitively know the temperature of the outer surface of the barbecue temperature probe without the help of other devices, and judge whether the temperature has dropped to a level where the food probe can be picked up by hand.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a barbecue temperature probe according to an embodiment of the present application.

FIG. 2 is an exploded view of the barbecue temperature probe according to an embodiment of the present application.

FIG. 3 is a schematic structural view of the barbecue temperature probe according to an embodiment of the present application.

FIG. 4 is a cross-sectional view of the barbecue temperature probe according to an embodiment of the present application.

FIG. 5 is an exploded view of the barbecue temperature probe according to an embodiment of the present application.

FIG. 6 is a cross-sectional view of the barbecue temperature probe according to an embodiment of the present application.

FIG. 7 is an enlarged view at point A in FIG. 6.

FIG. 8 is an exploded view of the barbecue temperature probe according to an embodiment of the present application.

FIG. 9 is a schematic structural view inside a shell of the barbecue temperature probe according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that directional indications, such as up, down, left, right, front, back, etc., involved in the embodiments of the present application are only used to explain the relative positional relationship, movement and the like between various parts in a specific posture, (as shown in the figure). If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

The present application provides a barbecue temperature probe and a stylus.

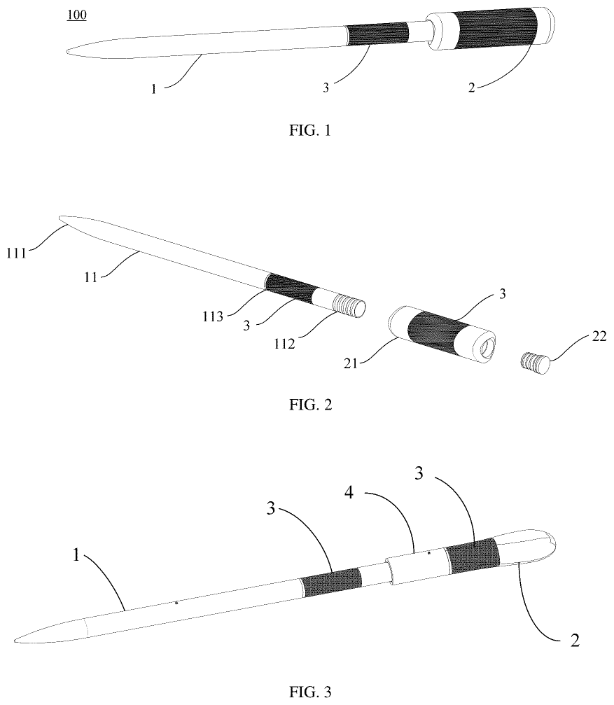

Referring to FIG. 1 and FIG. 2, in an embodiment, the present application provides a barbecue temperature probe 100, including a measuring portion 1, a holding portion 2 and a temperature sensing portion 3. The measuring portion 1 includes a needle body 11 and a temperature sensor 12, and the temperature sensor 12 is fixedly installed in the needle body 11 for converting the temperature signal of the needle body 11 into an electrical signal. The holding portion 2 is fixedly connected to one end of the measuring portion 1, and the temperature sensing portion 3 is provided on the outer surface of the measuring portion 1 and/or the holding portion 2, so as to sense the temperature of the outer surface of the barbecue temperature probe 100 and change its own morphological characteristics with the temperature change.

In this embodiment, the measuring portion 1 is made of stainless steel material with high temperature resistance and fast heat conduction to form a thin and long strip outer needle body 11, and the temperature sensor 12 is fixed in the needle body 11. The probe can be easily inserted into various ingredients by virtue of its thin and long shape to detect the internal temperature of the ingredients. The stainless steel material has high stability, which does not react with food to pollute the ingredients, and can isolate the food from its internal electronic elements.

At the same time, the fast heat conduction performance can quickly sense the temperature of the contacted object and convert the temperature information into an electrical signal to transmit to other electronic elements to pass the temperature information to the user. The holding portion 2 is made of a material with high temperature resistance and low heat conductivity such as ceramics, and is sealed and connected to the measuring portion 1. Different connection methods can be adopted according to actual usage. If the barbecue temperature probe 100 is charged by wireless charging, a fixed connection method such as non-detachable welding or super glue can be adopted. If the barbecue temperature probe 100 can be charged by replacing the internal battery, a detachable buckle slot or a thread connection method can be adopted. It is only necessary to ensure that the holding portion 2 and the measuring portion 1 do not fall out when the barbecue temperature probe 100 is working, and the oil smoke or water cannot enter the needle body 11 from the connection between the holding portion 2 and the measuring portion 1. The temperature sensing portion 3 is provided on the outer surface of the barbecue temperature probe 100 to detect the temperature of the outer surface of the barbecue temperature probe 100, which can reversibly change its own state characteristics with temperature changes. The state characteristics can be the color of the temperature sensing portion 3, the volume of the temperature sensing portion 3, or the measurement scale of the temperature sensing portion 3. In this embodiment, the temperature sensing portion 3 can change color as the temperature rises and falls. After cooking is finished or when the barbecue temperature probe 100 is placed in water to measure the water temperature, the user can determine whether the temperature of the outer surface of the barbecue temperature probe 100 has dropped to a level that can be directly touched by hands based on the degree of color change, and pull the barbecue temperature probe 100 out of the food or take it out of the water.

In the technical solution of the present application, the external temperature is sensed through the temperature sensor 12 in the measuring portion 1 of the barbecue temperature probe 100 to indicate the temperature of the stuff under test, the food probe is inserted into the stuff under test through the holding portion 2, and the temperature sensing portion 3 is provided on the measuring portion 1 and/or the holding portion 2. The temperature sensing portion 3 can change its own state with the temperature change of the outer surface of the measuring portion 1 and the holding portion 2, and indicates the temperature of the outer surface of the measuring portion 1 and the holding portion 2 at this time through the change of the state of the temperature sensing portion 3. The barbecue temperature probe 100 in the technical solution of the present application senses the temperature of the outer surface of the barbecue temperature probe 100 through the temperature sensing portion 3 and changes its own morphological characteristics with the temperature, so that the user can intuitively know the temperature of the outer surface of the barbecue temperature probe 100 without the help of other devices, and can determine whether the temperature drops to a level that allows the food probe to be picked up by hands.

Referring to FIG. 1 and FIG. 2, in an embodiment, the needle body 11 includes a middle tube, and a tip end 111 and a connecting end 11 provided at two opposite ends of the middle tube. The diameter of the tip end 111 gradually decreases from the middle tube towards the direction away from the connecting end 112. The connecting end 112 is configured for fixed connection to the holding portion 2. The tip end 111 can make it easier for the needle body 11 to be inserted into harder food to better detect the degree of food cooking. The tip end 111 and the middle tube are both made of stainless steel and can be manufactured in an integral molding manner, or the tip end 111 and the middle tube can be manufactured separately and then sealed and spliced, so that the tip end 111 can be more convenient to replace after deformation, saving material costs. The diameter of the holding portion 2 is larger than that of the needle body 11. After being fixedly connected with the needle body 11, the user can insert the needle body 11 into the food by grabbing the holding portion 2. Compared with the smooth stainless steel surface of the needle body 11, the holding portion 2 can be made of a high-temperature resistant material with higher friction, or a concave-convex texture can be added to the holding portion 2 to increase the friction, so that the user can more easily insert the barbecue temperature probe 100 into the food through the holding portion 2.

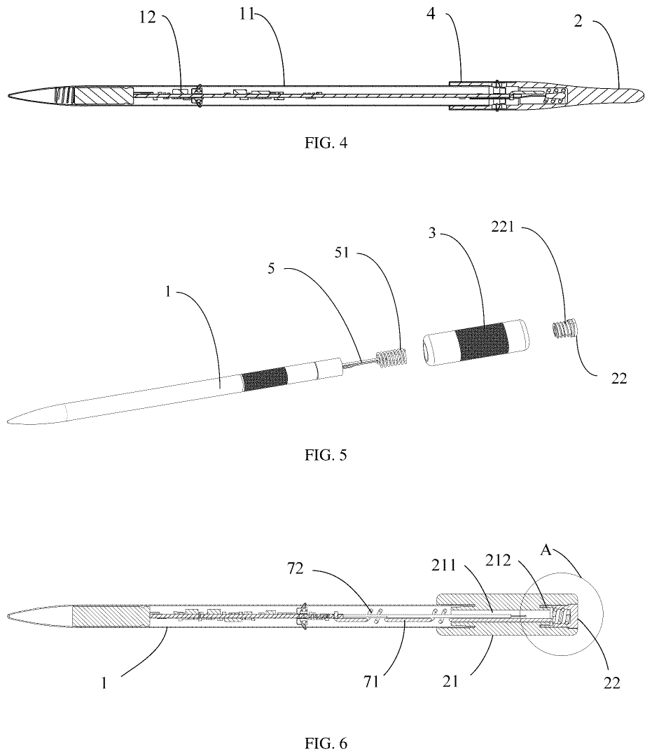

Referring to FIG. 3 and FIG. 4, in an embodiment, the barbecue temperature probe 100 further includes a conductive member 4, provided at one end of the holding portion 2 close to the needle body 11, and the temperature sensor 12 is electrically connected to the conductive member 4, so that the conductive member 4 is configured as a charging electrode. The conductive member 4 is installed at one end of the holding portion 2 close to the needle body 11 as a positive charging electrode, that is, installed at the front end close to the needle body 11, so that the holding portion 2 can be easy for the user to take and use, and this can give the handle more appearance design possibilities. At the same time, the tail end of the handle is made of the same material, the appearance is better, and there is no scratchy feeling, which improves the user's experience. As long as the material itself can resist high temperatures, there will be no problem of damage after thermal expansion, thereby avoiding problems such as burns. Therefore, this design can resist high temperatures and improve the safety of use.

Referring to FIG. 1 and FIG. 2, in an embodiment, the holding portion 2 includes a hollow cylinder 21 and an end cover 22, and the end cover 22 is sealed and provided at an opening of one end of the hollow cylinder 21. One end of the hollow cylinder 21 away from the end cover 22 is sleeved on the outside of the connecting end 112, one end of the hollow cylinder 21 is sealed and connected to the connecting portion, and the other end of the hollow cylinder 21 is sealed and connected to the end cover 22, so that all outlets of the hollow cylinder 21 are sealed. In a cooking environment, it can prevent the oil smoke or moisture from entering the barbecue temperature probe 100 from the hollow cylinder 21, avoiding damage to the electronic elements inside the barbecue temperature probe 100.

Referring to FIG. 2, in an embodiment, the peripheral wall of the connecting end 112 is provided with a plurality of annular grooves, and a sealing member is provided in the annular groove. The sealing member is configured to seal and connect the inner circumferential wall of the hollow cylinder 21 with the peripheral wall of the connecting end 112. The sealing member can be made of a deformable material such as silica gel, and a slightly larger sealing member is inserted into each annular groove so that the sealing member fills the groove gap and is slightly higher than the groove. During assembly, the hollow cylinder 21 is sleeved outside the groove of the connecting end 112, and the sealing member in the groove can fill the gap between the connecting end 112 and the hollow cylinder 21 through its own deformation, thereby isolating external oil smoke or moisture from entering the barbecue temperature probe 100 from the gap between the connecting end 112 and the hollow cylinder 21.

In an embodiment, the end cover 22 includes a top plate and a connecting column extending from the top plate towards one side. The peripheral wall of the connecting column is provided with a clamping groove. The connecting column is inserted into the hollow cylinder 21. The clamping groove is configured to clamp with the inner sidewall of the hollow cylinder 21. The shape of the clamping groove on the connecting column is matched with the shape of the inner wall of the hollow cylinder 21, which can limit the end cover 22 in the hollow cylinder 21. If it is necessary to increase the sealing performance, silicone or sealing materials such as glue can be inserted into the gap at the clamping groove before inserting the end cover 22, so as to ensure the sealing performance of the end cover 22.

In an embodiment, the temperature sensing portion 3 is provided in the middle of the outer wall of the hollow cylinder 21 and the area touched by the user's finger, so that the temperature detected by the temperature sensing portion 3 is the position where the user grabs when taking out the barbecue temperature probe 100, thereby reminding and indicating the user whether the temperature of the area has dropped to a touchable temperature, and preventing the user from grabbing the barbecue temperature probe 100 too early when the user does not know the temperature of the outer surface of the barbecue temperature probe 100.

Referring to FIG. 5, in an embodiment, the barbecue temperature probe 100 further includes a radio frequency antenna 5 electrically connected to the temperature sensor 12, and a thread portion 221 is provided on the end cover 22. The radio frequency antenna 5 includes a spiral portion 51 threadedly connected to the thread portion 221 of the end cover 22. In order to more stably connect the radio frequency antenna 5 with the end cover 22, the shape of the radio frequency antenna 5 can be a spring shape, a tube shape, or a rod shape, which is not specifically limited here. At the same time, the radio frequency antenna 5 is made of conductive materials such as copper or stainless steel. In order to form a good connection between the radio frequency antenna 5 and the end cover 22, the number of turns of the spiral portion 51 of the radio frequency antenna 5 is not less than two. In this way, the radio frequency antenna 5 can be stably connected to the end cover 22 to avoid oxidation and poor contact caused by high temperature.

Referring to FIG. 6, in an embodiment, the hollow cylinder 21 is provided with an accommodating chamber 211, and a first opening and a second opening are provided at two opposite ends of the accommodating chamber 211. The connecting end 112 is in sealed connection with the first opening, and the end cover 22 is in sealed connection with the second opening. The second opening is provided with a waterproof structure 212. In addition to being in sealed connection through the sealing groove and the sealing member, the second opening at one end of the accommodating chamber 211 is further provided with a waterproof structure 212, which can further improve the waterproof performance of the needle body 11 of the barbecue temperature probe 100, thereby extending the service life of the barbecue temperature probe 100.

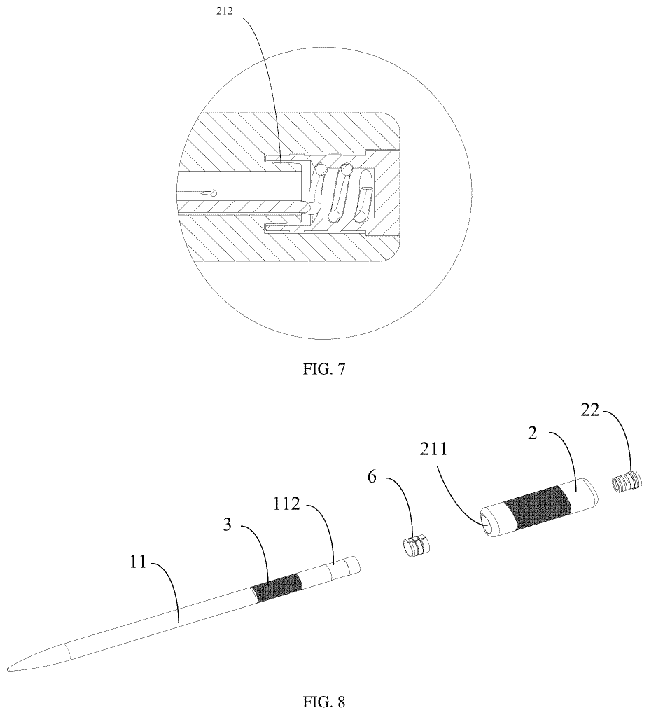

Referring to FIG. 6 and FIG. 7, in an embodiment, the waterproof structure 212 includes a reverse interlock protruding from the inner wall of the accommodating chamber 211, and a gap is formed between the reverse interlock and the inner wall of the accommodating chamber 211. The end cover 22 is inserted into the gap. In this way, even if water accidentally enters from the gap between the end cover 22 and the holding portion 2, it can only enter the bottom of the gap between the reverse interlock and the accommodating chamber 211 under the obstruction of the reverse interlock, and will not enter the holding portion 2, thereby improving the service life of the barbecue temperature probe 100. In addition, the gap also has the function of guiding and limiting, so that the end cover 22 can enter according to the preset trajectory when it is inserted into the gap, and stop when it reaches the bottom.

In an embodiment, the reverse interlock is provided at one end of the accommodating chamber 211 close to the second opening, and the outer diameter of the reverse interlock gradually increases from the second opening towards the accommodating chamber 211. The outer diameter gradually increases along the opening toward the accommodating chamber 211, so that the end cover 22 is gradually tightened when inserted into the gap between the reverse interlock and the inner wall, and the end cover 22 is more firmly inserted into the gap and can be gradually clamped when entering the gap, thereby achieving better waterproof performance.

Referring to FIG. 8, in an embodiment, the barbecue temperature probe 100 further includes a metal sealing member 6 sleeved on the periphery of the connecting end 112, and the metal sealing member 6 can be deformed under the action of external force so that the diameter of the metal sealing member 6 can be adjusted. The metal sealing member 6 is in an interference fit with the inner wall of the accommodating chamber 211, so that the connecting end 112 is in sealed connection with the body. The diameter of the metal sealing member 6 is adjustable, and the connecting end 112 is provided with an annular groove. Before the metal sealing member 6 is installed in the annular groove, the inner diameter of the metal sealing member 6 can be adjusted to be larger than that of the needle body 11, so that the metal sealing member 6 can be smoothly penetrated by the needle body 11. Then, the inner diameter of the metal sealing member 6 is reduced to the same diameter as the outer wall at the connection, so that the metal sealing member 6 can be buckled in the connecting end 112. The holding portion 2 is sleeved on the connection of the shell and completely covers the metal sealing member 6. At the same time, a colloid is filled between the holding portion 2 and the connecting end 112, and between the metal sealing member 6 and the needle body 11, so that the connecting end 112 between the holding portion 2 and the needle body 11 can be sealed.

In an embodiment, the metal sealing member 6 is in a non-closed ring shape with an opening; and/or the metal sealing member 6 is made of copper, which is a ductile and chemically stable metal, and can be adjusted into a desired shape by tearing. It is not easy to rust and change the shape of the copper too much even if it is exposed to high temperature and oil smoke for a long time, thus it is a good material for metal sealing member 6. Therefore, in this embodiment, a sleeve made of copper is configured as the metal sealing member 6. An opening is opened on the side wall of the copper sleeve to make the diameter adjustable, so that the diameter of the copper sleeve can be adjusted according to the diameter of the needle body 11.

In an embodiment, the outer diameter of the metal sealing member 6 gradually decreases from the end close to the first opening towards the inside of the accommodating chamber 211. The metal sealing member 6 includes a sealing body and a convex rib provided on the outer periphery of the sealing body. The convex rib is in an interference-fit with the inner wall of the accommodating chamber 211. A plurality of convex ribs are provided at intervals along the axial direction of the metal sealing member 6. A groove for filling colloid is formed between any two adjacent convex ribs. The end of the copper sleeve with a smaller outer diameter is close to the holding portion 2, so that the connecting end 112 after the copper sleeve is installed can enter more easily from the first opening of the holding portion 2. The outer shape with gradually increasing outer diameter can form a slope on the outer wall of the metal sealing member 6, so that the holding portion 2 can be easily sleeved to the end of the metal sealing member 6 along the slope, and can also achieve interference fit with the metal sealing member 6. The convex rib is provided on the periphery of the sealing body, which not only to prevent the holding portion 2 from separating from the shell, but also prevent liquid or gas from penetrating from the gap between the sealing member and the accommodating chamber 211, thereby ensuring the normal operation of the internal element and enhancing the sealing effect. The number, shape, size and distribution of the convex rib affect the sealing effect. In practical applications, it can be set according to the specific ambient temperature of the barbecue temperature probe 100.

Referring to FIG. 1 and FIG. 2, in an embodiment, the needle body 11 is provided with a safety line 113 for marking the depth of the needle body 11 inserted into the food. The temperature sensing portion 3 is provided on the needle body 11 on one side of the safety line 113 close to the holding portion 2. The safety line 113 can be a groove or a convex block provided on the stainless steel needle body 11, or a color line mark engraved on the needle body 11 using a safe and high temperature resistant material, and is provided at the middle and upper part of the needle body 11. When in use, the barbecue temperature probe 100 is inserted to the position of the safety line 113, which can more accurately test the temperature of the food. The temperature sensing portion 3 is tightly close to the safety line 113. When the needle body 11 is inserted into the food and reaches the position of the safety line 113, the position sensed by the temperature sensing portion 3 is the position of the safety line 113. Since the barbecue temperature probe 100 is only inserted to the position of the safety line 113, the needle body 11 above the safety line 113 to the handle is exposed outside of the stuff under test. Therefore, the approximate temperature of the outer surface of the needle body 11 at the position of the safety line 113 can be directly determined by visually observing the state change of the temperature sensing portion 3, thereby speculating the approximate cooking degree of the stuff under test.

In an embodiment, the temperature sensing portion 3 is coated with a thermochromic coating, and the thermochromic coating can change color with temperature changes. In this embodiment, the thermochromic coating can darken with increasing temperature, and can gradually return to the original color when the temperature drops. A certain color depth range is set as a touchable temperature range, and the user can intuitively determine the temperature of the outer surface of the barbecue temperature probe 100 at this time through the shade of the color.

In an embodiment, a control module and a battery module for power supply are also provided. The control module is electrically connected to the temperature sensor 12, and the battery module is electrically connected to the control module and the temperature sensor 12. The temperature information of the needle body 11 sensed by the temperature sensor 12 is transmitted to the control module through an electrical signal, and is transmitted to an external wireless device through the control module, so that the user can know the specific temperature value of the stuff under test. The battery module supplies power to the control module to ensure that the barbecue temperature probe 100 can continue to work during the entire cooking process and transmit the temperature information of the stuff under test to the user.

In an embodiment, the barbecue temperature probe 100 further includes a temperature-sensing member and a spiral antenna 7. The temperature-sensing member is provided in the needle body 11 and along the extending direction of the needle body 11. The spiral antenna 7 is provided in the needle body 11. The spiral antenna 7 includes an antenna body 71 provided along the extending direction of the needle body 11, and a spiral structure 72 provided in the middle section of the antenna body 71. The spiral structure 72 is around the periphery of the temperature-sensing member. The flattened antenna is wound around the first direction for a certain number of turns with the same diameter from any point in the middle section of the antenna body 71, and the antenna body 71 is further extended along the first direction, so that a spiral antenna is formed in the middle section of the antenna body 71. The middle of the spiral antenna is hollowed out and the temperature-sensing member can be provided therein. The winding diameter of the spiral section can be determined according to the size of the temperature-sensing member, so that the temperature-sensing member can be smoothly inserted without falling out. The spiral structure 72 can also adjust the length of the antenna by telescoping, so as to adapt to space structures of different sizes. At least one spiral structure 72 is provided, or a plurality of spiral structures are provided according to the length of the temperature-sensing member so that the temperature-sensing member and the spiral antenna 7 are more firmly fixed to each other. The temperature-sensing member is a thermocouple, which is a commonly used temperature measuring element in temperature measuring instruments. It can directly measure temperature and convert the temperature signal into a thermoelectric potential signal. The signal is then processed by a circuit board and fed back to an electronic terminal via radio so that the user can know the temperature information. In temperature measurement, the thermocouple is widely used, which has many advantages such as simple structure, convenient manufacturing, wide measurement range, high accuracy, small inertia, and convenient remote transmission of output signals. In addition, since the thermocouple is a passive sensor, it can transmit temperature information without an external power supply during measurement, and is very convenient to use. The temperature-sensing member is configured to sense the temperature of the environment and transmit the temperature information to the circuit board. The temperature-sensing member can be coaxially provided and fixed with the antenna under the winding of the spiral structure 72 in the spiral antenna 7, without the need for other fixed members made of high-temperature resistant materials, thereby saving material costs and assembly costs.

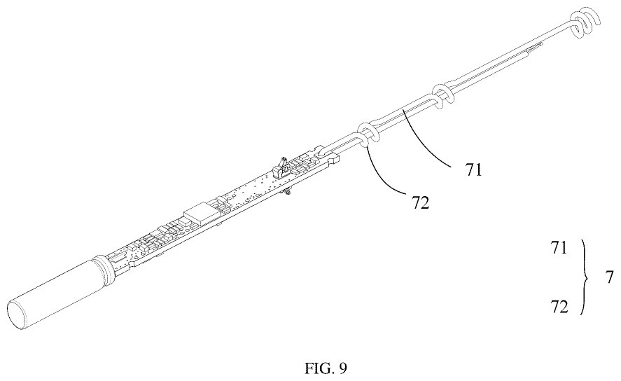

Referring to FIG. 9, in an embodiment, a plurality of spiral structures 72 are coaxially provided at intervals along the extending direction of the needle body 11. The spiral structure 72 includes at least one spiral section provided along the extending direction of the needle body 11. The number of spiral structures 72 can be increased or decreased according to the length or center of gravity position of the enclosed temperature-sensing member, so as to improve the stability of the temperature-sensing member and the spiral structure 72, and to prevent the temperature-sensing member from being separated from the antenna and falling out during use. The number of turns of the spiral section can also be increased or decreased according to the length, mass or shape of the temperature-sensing member to be wound. When the number of winding turns increases, the structural stability of the temperature-sensing member and the spiral antenna 7 can be enhanced, and when the number of winding turns decreases, the side length of the spiral antenna 7 can be reduced, thereby reducing material loss, saving costs, and increasing economic benefits.

In an embodiment, the spiral antenna 7 further includes a first connecting portion provided at one end of the antenna body 71, and the barbecue temperature probe 100 further includes a circuit board provided in the shell. The first connecting portion is connected to the circuit board. The first connecting portion is detachably connected or fixedly connected to a corresponding connecting structure provided on the circuit board, so as to fix the spiral antenna 7 on the circuit board, thereby preventing the spiral antenna 7 from being disconnected from the circuit board and failing to establish a connection, resulting in failure to measure temperature. The circuit board is configured to convert the information of the external environment into an electrical signal after processing, and transmit it to an external electronic terminal, so that the user can remotely monitor the temperature through electronic products such as mobile phones, thereby improving the convenience of the barbecue temperature probe 100.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields, are included in the scope of the present application.

What is claimed is:

1. A barbecue temperature probe, comprising:
a measuring portion comprising a needle body and a temperature sensor, wherein the temperature sensor is fixedly installed in the needle body and configured to convert a temperature signal of the needle body to an electrical signal;
a holding portion fixedly connected to one end of the measuring portion; and
a temperature sensing portion provided on an outer surface of the measuring portion and an outer surface of the holding portion, wherein the temperature sensing portion is configured to sense a temperature of an outer surface of the barbecue temperature probe and change morphological characteristics with a temperature change.

2. The barbecue temperature probe of claim 1, wherein the needle body comprises: a middle tube, and a tip end and a connecting end provided at both ends of the middle tube;
a diameter of the tip end is configured to gradually decrease from the middle tube towards a direction away from the connecting end, and the connecting end is fixedly connected to the holding portion.

3. The barbecue temperature probe of claim 1, further comprising a conductive member provided at one end of the holding portion close to the needle body, wherein the temperature sensor is electrically connected to the conductive member, so that the conductive member is configured as a charging electrode.

4. The barbecue temperature probe of claim 2, wherein the holding portion comprises a hollow cylinder and an end cover, the end cover is provided at an opening of one end of the hollow cylinder, and one end of the hollow cylinder away from the end cover is sleeved on an outside of the connecting end.

5. The barbecue temperature probe of claim 4, wherein a peripheral wall of the connecting end is provided with a plurality of annular grooves, and a sealing member is provided in the annular groove and configured to seal and connect an inner circumferential wall of the hollow cylinder with the peripheral wall of the connecting end.

6. The barbecue temperature probe of claim 4, wherein the end cover comprises a top plate and a connecting column extending from the top plate towards one side of the top plate, a peripheral wall of the connecting column is provided with a clamping groove, the connecting column is inserted into the hollow cylinder, and the clamping groove is configured to clamp with an inner sidewall of the hollow cylinder.

7. The barbecue temperature probe of claim 4, wherein the temperature sensing portion is provided at a middle part of an outer wall of the hollow cylinder where is touched by user's fingers.

8. The barbecue temperature probe of claim 4, further comprising a radio frequency antenna electrically connected to the temperature sensor, wherein a thread portion is provided on the end cover, and the radio frequency antenna comprises a spiral portion threadedly connected to the thread portion of the end cover.

9. The barbecue temperature probe of claim 4, wherein the hollow cylinder is provided with an accommodating chamber, a first opening and a second opening are provided at two ends of the accommodating chamber, the connecting end is sealingly connected to the first opening, and the end cover is sealingly connected to the second opening; and
the second opening is provided with a waterproof structure.

10. The barbecue temperature probe of claim 9, wherein the waterproof structure comprises a reverse interlock protruding from an inner wall of the accommodating chamber, a gap is formed between the reverse interlock and the inner wall of the accommodating chamber, and the end cover is inserted into the gap.

11. The barbecue temperature probe of claim 10, wherein the reverse interlock is provided at one end of the accommodating chamber close to the second opening, and an outer diameter of the reverse interlock is configured to gradually increase from the second opening towards the accommodating chamber.

12. The barbecue temperature probe of claim 10, further comprising a metal sealing member sleeved on a periphery of the connecting end, wherein the metal sealing member is configured to be deformed under an action of an external force, so that a diameter of the metal sealing member is adjustable; and
the metal sealing member is in an interference fit with the inner wall of the accommodating chamber to sealingly connect the connecting portion to the body.

13. The barbecue temperature probe of claim 12, wherein the metal sealing member is in a non-closed ring shape with an opening; and
the metal sealing member is made of copper.

14. The barbecue temperature probe of claim 12, wherein an outer diameter of the metal sealing member is configured to gradually decrease from one end close to the first opening towards an inside of the accommodating chamber, the metal sealing member comprises a sealing body and a convex rib provided on an outer periphery of the sealing body, and the convex rib is in an interference fit with the inner wall of the accommodating chamber; and
a plurality of convex ribs are provided at intervals along an axial direction of the metal sealing member, and a groove for filling colloid is formed between any two adjacent convex ribs.

15. The barbecue temperature probe of claim 1, wherein the needle body is provided with a safety line for marking a depth of the needle body inserted into food; and
the temperature sensing portion is provided on one side of the needle body close to the holding portion and outside the safety line.

16. The barbecue temperature probe of claim 1, wherein the temperature sensing portion is coated with a thermochromic coating configured to change color with the temperature change.

17. The barbecue temperature probe of claim 1, further comprising a control module and a battery module for power supply, wherein the control module is electrically connected to the temperature sensor, and the battery module is electrically connected to the control module and the temperature sensor.

18. The barbecue temperature probe of claim 1, further comprising a temperature-sensing member and a spiral antenna, wherein
the temperature-sensing member is provided in the needle body and along an extending direction of the needle body, and the spiral antenna is provided in the needle body;
the spiral antenna comprises an antenna body provided along the extending direction of the needle body, and a spiral structure provided in a middle section of the antenna body; and
the spiral structure is provided around a periphery of the temperature-sensing member.

19. The barbecue temperature probe of claim 18, wherein a plurality of the spiral structures are coaxially provided at intervals along the extending direction of the needle body, and the spiral structure comprises at least one spiral section provided along the extending direction of the needle body.

20. The barbecue temperature probe of claim 18, further comprising a circuit board provided in the shell, wherein the spiral antenna further comprises a first connecting portion provided at one end of the antenna body, and the first connecting portion is connected to the circuit board.
